(19) United States
(12) Patent Application Publication
(10) Pub. No.: US 2006/0049991 A1
(43) Pub. Date: Mar. 9, 2006

(54) System and method for directional transmission and reception of signals

(76) Inventor: Hans Gregory Schantz, Huntsville, AL (US)

Correspondence Address: Dr. Hans Schantz, 515 Sparkman Drive, Huntsville, AL, 35816, US

(21) Appl. No.: 11/214,096

(22) Filed: Aug. 29, 2005

Related U.S. Application Data
(60) Provisional application No. 60/607,441, filed on Sep. 3, 2004.

(51) Int. Cl. H01Q 13/10

(52) U.S. Cl. 343/700 MS; 343/767

(57) ABSTRACT

A system and method for directional transmission and reception of signals, including ultrawideband signals, includes an RF device and an antenna structure comprising (a) a feed structure, (b) an angular transition, and (c) a plurality of electrically isolated radiating elements. In alternate embodiments an antenna structure is a substantially planar antenna structure and a plurality of electrically isolated radiating elements comprise a first electrically isolated radiating element and a second electrically isolated radiating element. A first electrically isolated radiating element and a second electrically isolated radiating element may cooperate to form a substantially elliptically tapered slot horn, or a substantially linear tapered slot horn. A substantially linear tapered slot horn may terminate in a substantially elliptical termination. A feed axis and a radiating axis may be aligned at an angle φ not equal to zero (φ≠0) such as an angle φ equal to 90 degrees.

This application claims benefit of prior filed copending Provisional Patent Application Serial No. 60/607,441, filed Sep. 3, 2004.

### BACKGROUND OF THE INVENTION

1. Field of the Invention

The present invention is directed to electromagnetic signal handling, and especially to directional transmission and reception of electromagnetic signals.

2. Prior Art

Prior art techniques and apparatuses for directional transmission and reception of electromagnetic signals have included planar horns generally aligned along a single axis. An example of such a prior art planar horn was taught by Nester (U.S. Pat. No. 4,500,887). A planar antenna generally aligned along a single axis must have sufficient length to effect a gradual transition between a transmission line and radiating elements. In many cases, this transition may be comparable in size to the radiating elements themselves yielding a large and ungainly form factor.

Also, alignment of a planar antenna generally along a single axis severely limits the options available to an overall system designer for integrating an antenna onto the same printed circuit board as an RF device. Such an integration of an RF device with a prior art planar antenna results in an even more ungainly and difficult to implement form factor.

In commercial practice, a compact form factor has significant advantages. The closer a planar antenna is to a circle with generally consistent extent in all directions, the less material is needed for an enclosure and support structure. Also a compact form factor allows an antenna to be used in more operational environments.

Furthermore, prior art planar antennas typically involve a single, electrically connected, radiating element. Examples of such antennas include those of Aiello et al (U.S. Pat. Nos. 6,292,153 and 6,246,377). Prior art planar antennas with a single, electrically connected, radiating element typically require an elaborate feed structure for coupling and impedance matching. Typical prior art feed structures have characteristic dimensions on the order of a quarter wavelength at a desired lower frequency. FIGS. 1 and 2 illustrate such prior art antennas. The bulky feed structures of such prior art antennas make them difficult to manufacture in a compact form factor.

There is a need for a compact form factor planar horn antenna to minimize the weight and expense of an enclosure and support system. There is a further need for a compact form factor planar horn antenna with the flexibility to be used in a variety of orientations with respect to an RF device. Finally, there is a need for a planar horn antenna with electrically isolated radiating elements that will accommodate a feed structure in a compact form factor.

### SUMMARY OF THE INVENTION

A system and method for directional transmission and reception of signals, including ultrawideband signals, includes an RF device and an antenna structure comprising (a) a feed structure, (b) an angular transition, and (c) a plurality of electrically isolated radiating elements. In alternate embodiments an antenna structure is a substantially planar antenna structure and a plurality of electrically isolated radiating elements comprise a first electrically isolated radiating element and a second electrically isolated radiating element. A first electrically isolated radiating element and a second electrically isolated radiating element may cooperate to form a substantially elliptically tapered slot horn, or a substantially linear tapered slot horn. A substantially linear tapered slot horn may terminate in a substantially elliptical termination. A feed axis and a radiating axis may be aligned at an angle φ not equal to zero (φ≠0) such as an angle φ equal to 90 degrees.

In still further embodiments, a system and method for directional transmission and reception of signals includes a dual polarization antenna system further including a first substantially planar antenna element comprising (a) a feed structure, (b) an angular transition, and (c) a plurality of electrically isolated radiating elements, as well as a second substantially planar antenna element oriented substantially orthogonally to a first substantially planar antenna element. A plurality of electrically isolated radiating elements of a first substantially planar antenna element may cooperate to form a slot horn. A slot horn may be a substantially elliptically tapered slot horn or a substantially linear tapered slot horn.

In another embodiment, a system and method for directional transmission and reception of signals includes an RF device and a substantially planar antenna structure comprising a plurality of electrically isolated radiating elements generally oriented along a radiating axis, and a feed structure generally oriented along a feed axis. A radiating axis is generally oriented at an angle φ with respect to a feed axis, and angle φ is not equal to zero (φ≠0). A plurality of electrically isolated radiating elements may cooperate to form a slot horn. A slot horn may be a substantially elliptically tapered slot horn or a substantially linear tapered slot horn.

It is, therefore, an object of the present invention to provide a system and method for effecting directional transmission and reception of signals, including ultrawideband signals, with a compact form factor that reduces the size, weight, and expense of an enclosure or associated structure.

It is a further object of the present invention to provide an improved planar system for effecting directional transmission and reception of ultrawideband signals with flexibility to be mounted to or integrated with an associated RF device in a variety of orientation either alone or in an array.

A still further object of the present invention is to provide an improved planar apparatus for effecting directional transmission and reception of narrow band signals distributed across an ultra-wide frequency band.

Further objects and features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic of a first prior art planar horn antenna apparatus.

FIG. 2 is a schematic of a second prior art planar horn antenna apparatus.

FIG. 3 is a block diagram of an improved compact planar horn antenna apparatus.

FIG. 4 is a schematic diagram showing a preferred embodiment of an improved compact planar horn antenna apparatus.

FIG. 5 is a schematic providing an exploded view of the preferred embodiment in FIG. 4.

FIG. 6 is a schematic diagram showing an alternate embodiment in which a dielectric substrate is conformally tapered and with an alternate connection of radiating elements to a feed structure.

FIG. 7 is a schematic diagram illustrating an alternate embodiment in which a linearly tapered slot is terminated in an elliptical taper.

FIG. 8 is a schematic diagram illustrating an alternate embodiment with a co-planar radiating structure and an alternate feed structure.

FIG. 9 is a schematic diagram illustrating an alternate embodiment of the present invention used in an array.

FIG. 10 is a schematic diagram showing a side view of a dual polarization implementation of the present invention.

FIG. 11 is a schematic diagram showing a top view of a dual polarization implementation of the present invention.

The principle of reciprocity requires that reception and transmission properties of an antenna be reciprocal so that properties of an antenna are the same whether the antenna is employed for receiving signals or is employed for transmitting signals. Throughout this description, it should be kept in mind that discussions relating to transmitting or transmissions apply with equal veracity to reception of electromagnetic energy or signals, and vice versa.

### Prior Art Planar Horn Antennas

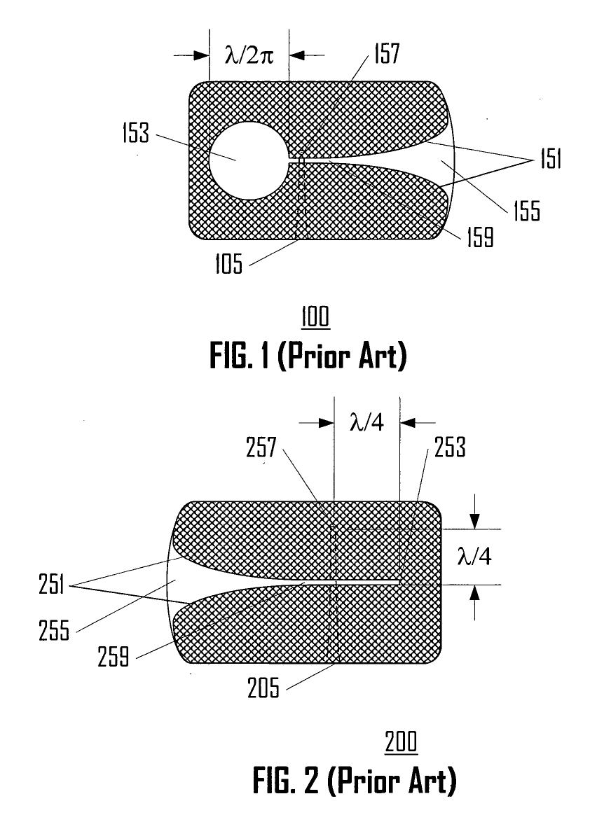

FIG. 1 is a schematic of a first prior art planar horn antenna apparatus 100. First prior art planar horn antenna apparatus 100 comprises feed structure 105 and radiating element 151. Feed structure 105 terminates in RF short (or via) 157. Radiating element 151 is a continuous, connected radiating element that encompasses slot 159. Slot 159 begins with RF open 153 and terminates in antenna aperture 155. RF open 153 is typically a relatively large structure, often needing to be as much as a half wavelength in circumference at a lower desired operating frequency. Because radiating element 151 is a continuous, connected radiating element, prior art planar horn antenna apparatus 100 requires a relatively sizeable and extensive coupling means (comprising RF open 153) for efficient coupling into slot 159. Such large, extensive, and sizeable coupling means are not conducive to a compact overall antenna form factor.

FIG. 2 is a schematic of a second prior art planar horn antenna apparatus 200. Second prior art planar horn antenna apparatus 200 comprises feed structure 205 and radiating element 251. Feed structure 205 terminates in RF open 257. RF open 257 is typically a quarter wavelength long at a lower desired operating frequency. Radiating element 251 is a continuous, connected radiating element that encompasses 259. Slot 259 begins with RF short 253 and terminates in antenna aperture 255. RF short 253 is typically a quarter wavelength long at a lower desired operating frequency. Because radiating element 251 is a continuous, connected radiating element, prior art planar horn antenna apparatus 200 requires a relatively sizeable and extensive coupling means (comprising RF open 257 and RF short 253) for efficient coupling into slot 259. Here again, such large, extensive, and sizeable coupling means are not conducive to a compact overall antenna form factor.

### DETAILED DESCRIPTION OF THE PREFERRED EMBODIMENT

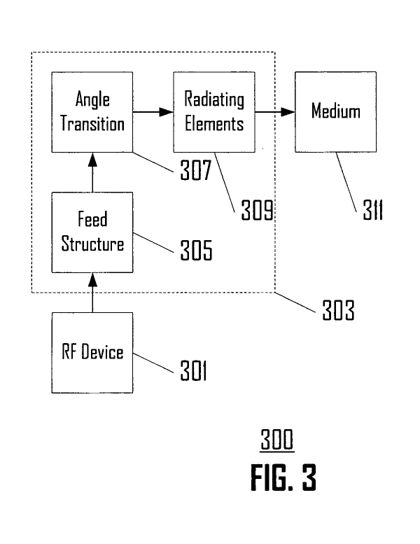

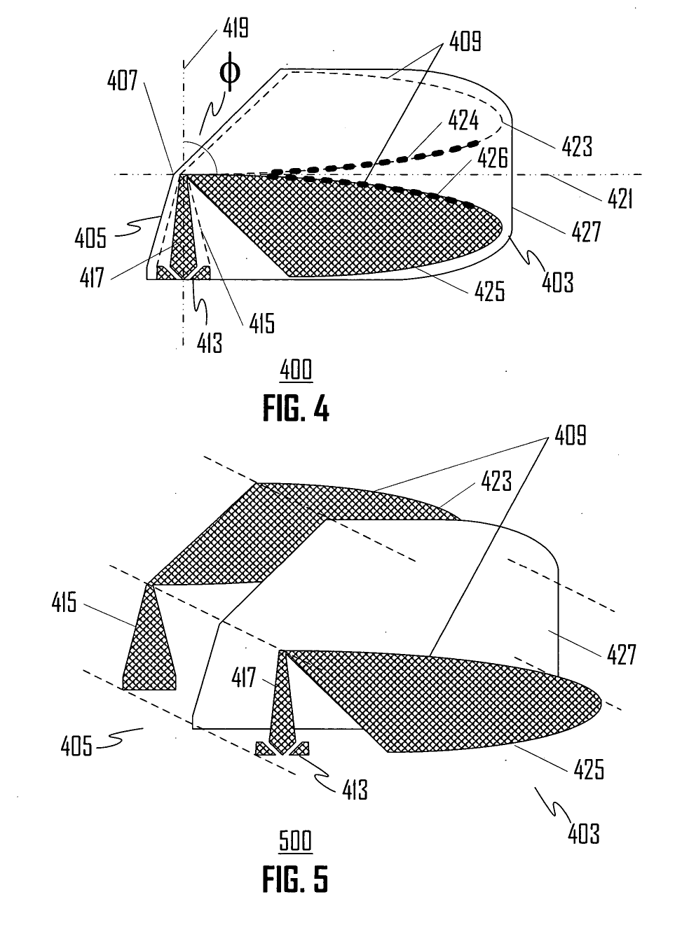

FIG. 3 is a block diagram of a compact planar horn antenna apparatus. An RF device 301 conveys signals to an associated antenna structure 303. Associated antenna structure 303 comprises a feed structure 305, angle transition 307, and electrically isolated radiating elements 309. Electrically isolated radiating elements 309 convey signals to an adjacent medium 311. Although angle transition 307 is shown as a discrete block, nothing precludes angle transition 307 from being distributed gradually along feed structure 105 and electrically isolated radiating elements 309. Electrically isolated radiating elements 309 enable a compact feed structure 305 as will be shown in detail in FIG. 4.

FIG. 4 is a schematic diagram showing a preferred embodiment 400 of an improved compact planar horn antenna apparatus 403. Preferred embodiment 400 is a compact planar horn antenna apparatus 403 comprising feed structure 405, angle transition 407, and electrically isolated radiating elements 409.

Feed structure 405 comprises interface means 413 to an RF device 301 (not shown), a first conducting line 415, and a second conducting line 417. Interface means 413 are depicted as pads suitable for attachment of an end launcher or other device to convey signals intermediate RF device 301 (not shown) and antenna structure 403. First conducting line 415, and second conducting line 417 cooperate to form a transmission line which conveys signals intermediate interface means 413 and angle transition 407. First conducting line 415, and second conducting line 417 are generally aligned with a feed axis 419. Further, first conducting line 415, and second conducting line 417 may be tapered to effect an impedance or unbalanced—balanced transition between interface means 413 and angle transition 407.

Angle transition 407 connects feed structure 403 (generally oriented along feed axis 419) to electrically isolated radiating elements 409 (generally oriented along radiating axis 421). Angle transition 407 yields an angle φ between feed axis 419 and radiating axis 421. In preferred embodiment 400, angle φ is substantially equal to 90 degrees. Angle transition 407 is essentially a means for coupling feed structure 405 to electrically isolated radiating elements 409 so as to yield desired angle φ between feed axis 419 and radiating axis 421.

Electrically isolated radiating elements 409 comprise first radiating element 423 and second radiating element 425. First radiating element 423 and second radiating element 425 are electrically isolated in the sense that they share no dc electrical connection. Thus, no extensive coupling or matching structures are necessary to connect first radiating element 423 and second radiating element 425 to first conducting line 415 and second conducting line 417, respectively. In preferred embodiment 400, first radiating element 423 is electrically connected to first conducting line 415 via angle transition 407 and second radiating element 425 is connected to second conducting line 417 via angle transition 407. Also in preferred embodiment 400, first radiating element 423 is characterized by first elliptical taper 424 and second radiating element 425 is characterized by second elliptical taper 426. Further, in preferred embodiment 400, first radiating element 423 and second radiating element 425 lie on opposing sides of a dielectric substrate 427 and cooperate to form a substantially elliptically tapered slot horn.

Although preferred embodiment 403 includes first radiating element 423 and second radiating element 425 cooperating to form an elliptically tapered slot horn, as in preferred embodiment 403, one skilled in the art will realize that alternate tapers are possible. A linear taper or an exponential taper, for instance, will yield results comparable to an elliptical taper. An elliptical taper (such as the combination of first elliptical taper 424 and second elliptical taper 426) is favored for good performance and ease of construction and design, but more complicated or alternate tapers to achieve a desired impedance transformation may yield better matching performance at the cost of significantly increased design and engineering expense.

FIG. 5 is a schematic providing an exploded view 500 of the preferred embodiment 403 in FIG. 4. First conducting line 415 and first radiating element 423 are electrically connected conducting media lying in a plane on a back side of dielectric substrate 427. Second conducting line 417 and second radiating element 425 are electrically connected conducting media lying in a plane on a front side of dielectric substrate 427. Interface means 413 also lie in a plane on a front side of dielectric substrate 427. Preferred embodiment 400 is thus a planar antenna with substantially planar, electrically isolated radiating elements 409 and substantially planar feed structure 405 on substantially planar dielectric substrate 427. Words like “front” and “back” are not used to imply a particular antenna orientation but only to aid the reader in understanding the illustrative exploded view 500 of FIG. 5. Also, although preferred embodiment 400 is shown as substantially planar antenna element 403, in alternate embodiments planar antenna element 403 may be gently curved or conformal to a curved surface.

### DETAILED DESCRIPTION OF ALTERNATE EMBODIMENTS

FIG. 6 is a schematic diagram showing an alternate embodiment 600 in which a dielectric substrate 627 is conformally tapered and with an alternate connection of electrically isolated radiating elements 609 to a feed structure 605. In alternate embodiment 600, first radiating element 423 is electrically connected to second conducting line 417 via angle transition 407 and second radiating element 425 is connected to first conducting line 415 via angle transition 407. Embodiment 600 is not preferred because the relatively close proximity of first conducting line 415 with second radiating element 425 may lead to undesired coupling that impairs antenna performance. Still alternate embodiment 600 may have useful application particularly if placement near a conducting enclosure is desired.

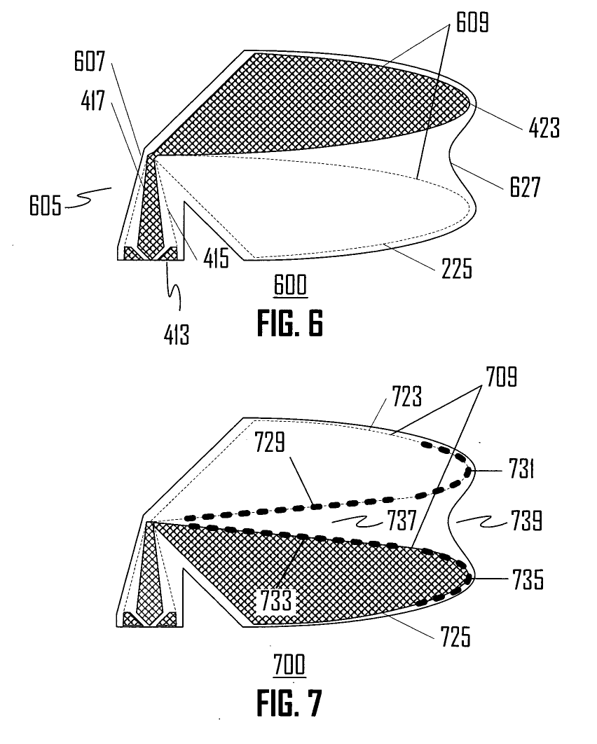

FIG. 7 is a schematic diagram illustrating an alternate embodiment 700 in which a linearly tapered slotline horn 737 is terminated in an elliptical taper termination 739. Electrically isolated radiating elements 709 comprise a first radiating element 723 and a second radiating element 725. First radiating element 723 has a first linear section 729 and a first elliptical termination 731. Second radiating element 725 has a second linear section 733 and a second elliptical termination 735. First linear section 729 and second linear section 733 cooperate to form linear taper slotline horn 737. First elliptical termination 731 and second elliptical termination 735 cooperate to form elliptical taper termination 739 to linearly tapered slotline horn 737.

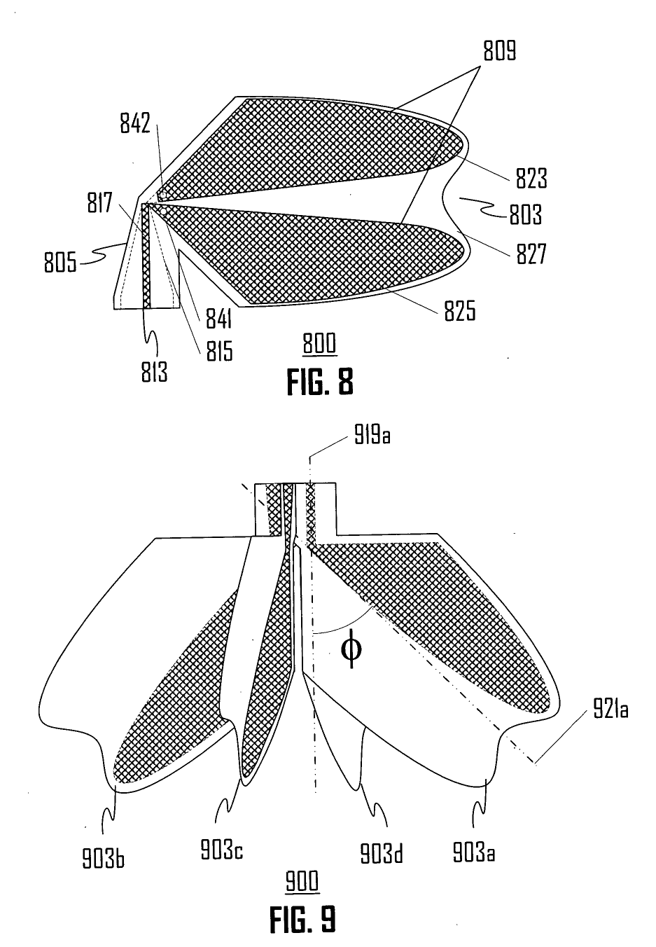

FIG. 8 is a schematic diagram illustrating an alternate embodiment 800 with co-planar electrically isolated radiating elements 809 and alternate feed structure 805. Alternate feed structure 805 comprises first conducting line 815, second conducting line 817, and interface means 813. Interface means 813 convey signals intermediate RF device 301 (not shown) and antenna structure 803. RF device 301 (not shown) may be co-located with antenna structure 803 on dielectric substrate 827. First conducting line 815 and second conducting line 817 cooperate to form a microstrip transmission line.

First via 842 couples first conducting line 815 to first radiating element 823. First radiating element 823 may be located on a front side of dielectric substrate 827, or a back side of dielectric substrate 827, or alternatively first radiating element 823 may comprise conducting elements on both sides of dielectric substrate 827. In alternate embodiments, second via 841 couples a front metallization to a back metallization of second radiating element 825.

FIG. 9 is a schematic diagram presenting a side view of alternate array embodiment 900 of the present invention. Alternate embodiment 900 is an array comprising first antenna element 903a, second antenna element 903b, third antenna element 903c, and fourth antenna element 903d. First feed axis 919a and radiating axis 921a. are oriented at angle φ. Angle φ is preferentially chosen so as to align radiating axis 921a in a desired direction to optimize pattern orientation and maximize coverage. Other antenna element (903b-d) are similarly oriented. Alternate embodiment 900 is well suited for use in a compact ceiling mounted RF device.

Antenna elements (903a-d) have a beam width of no more than about 90 degrees. Thus four antenna elements (903a-d) are shown in alternate embodiment 900 to provide coverage in all directions. Additional elements may provide better coverage for additional cost and complexity.

The compact size of antenna element 903a and other antennas elements taught by the present invention make them well suited for a variety of other array applications in addition to that shown in alternate embodiment 900.

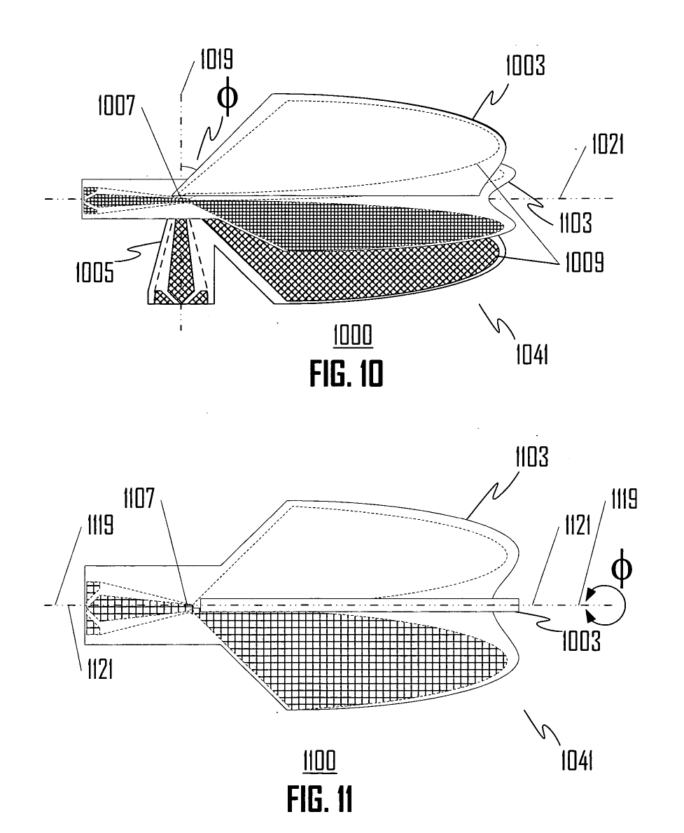

FIG. 10 is a schematic diagram showing a side view 1000 of a dual polarization implementation 1041 of the present invention. Dual polarization implementation 1041 comprises a first antenna element 1003 and a second antenna element 1103 (shown in more detail in FIG. 11). First antenna element 1003 and second antenna element 1103 are oriented substantially orthogonal to each other so as to be able to receive or transmit signals with orthogonal polarizations. First antenna element 1003 has feed structure 1005 and electrically isolated radiating elements 1009 oriented in “non-co-linear fashion:” radiating axis 1021 is oriented so as to be non-co-linear with feed axis 1019. Angle transition 1007 passes through second antenna element 1103 so as to couple feed structure 1005 with radiating elements 1003.

FIG. 11 is a schematic diagram showing a top view 1100 of dual polarization implementation 1041 of the present invention. Dual polarization implementation 1041 comprises a first antenna element 1003 (shown in more detail in FIG. 10) and a second antenna element 1103. Second antenna element has radiating axis 1121 oriented so as to be co-linear with feed axis 1119. Alignment of feed axis 1119 with radiating axis 1121 is not critical. For first antenna element 1003 and second antenna element 1103 to be easily collocated, one or both elements must be oriented in non-co-linear fashion.

First antenna element 1003 and second antenna element 1103 are preferentially co-located with a common phase center. Thus signals from first antenna element 1003 and second antenna element 1103 emerge with negligible phase difference or relative time delay.

Dual polarization implementation 1041 is suitable for receiving or transmitting polarization diverse signals such as circular or chiral polarization signals, as well as vertical or horizontal polarization signals.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

I Claim:

1. A system and method for directional transmission and reception of signals includes an RF device and an antenna structure comprising:
a) a feed structure,
b) an angular transition, and
c) a plurality of electrically isolated radiating elements.

2. A system and method for directional transmission and reception of signals as recited in claim 1 wherein said antenna structure is a substantially planar antenna structure.

3. A system and method for directional transmission and reception of signals as recited in claim 2 wherein said plurality of electrically isolated radiating elements comprise a first electrically isolated radiating element and a second electrically isolated radiating element.

4. A system and method for directional transmission and reception of signals as recited in claim 3 wherein said first electrically isolated radiating element and said second electrically isolated radiating element cooperate to form a substantially elliptically tapered slot horn.

5. A system and method for directional transmission and reception of signals as recited in claim 3 wherein said first electrically isolated radiating element and said second electrically isolated radiating element cooperate to form a substantially linear tapered slot horn.

6. A system and method for directional transmission and reception of signals as recited in claim 5 wherein said substantially linear tapered slot horn terminates in a substantially elliptical termination.

7. A system and method for directional transmission and reception of signals as recited in claim 3 wherein a feed axis and a radiating axis are aligned at an angle φ and wherein angle φ is not equal to zero (φ≠0).

8. A system and method for directional transmission and reception of signals as recited in claim 7 wherein a feed axis and a radiating axis are aligned at an angle φ and wherein angle φ is substantially equal to 90 degrees.

9. A system and method for directional transmission and reception of signals including a dual polarization antenna system said dual polarization antenna system comprising a first substantially planar antenna element and a second substantially planar antenna element, said first substantially planar antenna element comprising a
a) a feed structure,
b) an angular transition, and
c) a plurality of electrically isolated radiating elements, and
said second substantially planar antenna element oriented substantially orthogonally to said first antenna.

10. A system and method for directional transmission and reception of signals including a dual polarization antenna system as recited in claim 9 wherein a plurality of electrically isolated radiating elements cooperate to form a slot horn.

11. A system and method for directional transmission and reception of signals including a dual polarization antenna system as recited in claim 10 wherein said slot horn is a substantially elliptically tapered slot horn antenna.

12. A system and method for directional transmission and reception of signals including a dual polarization antenna system as recited in claim 10 wherein said slot horn is a substantially linearly tapered slot horn antenna.

13. A system and method for directional transmission and reception of signals including a dual polarization antenna system as recited in claim 10 wherein said slot horn terminates in a substantially elliptical taper.

14. A system and method for directional transmission and reception of signals includes an RF device and a substantially planar antenna structure comprising a plurality of electrically isolated radiating elements generally oriented along a radiating axis, and a feed structure generally oriented along a feed axis, said radiating axis generally oriented at an angle φ with respect to said feed axis, said angle φ not equal to zero (φ≠0).

15. A system and method for directional transmission and reception of signals as recited in claim 14 wherein a plurality of electrically isolated radiating elements cooperate to form a slot horn.

16. A system and method for directional transmission and reception of signals as recited in claim 15 wherein said slot horn is a substantially elliptically tapered slot horn antenna.

17. A system and method for directional transmission and reception of signals as recited in claim 15 wherein said slot horn is a substantially linearly tapered slot horn antenna.

18. A system and method for directional transmission and reception of signals as recited in claim 15 wherein said slot horn terminates in a substantially elliptical taper.
